(19) United States
(12) Patent Application Publication
(10) Pub. No.: US 2007/0206124 A1
(43) Pub. Date: Sep. 6, 2007

(54) Projection display apparatus

(75) Inventor: Jae-lim Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/651,592

(22) Filed: Jan. 10, 2007

(30) Foreign Application Priority Data
Mar. 3, 2006 (KR) 10-2006-0020652

(51) Int. Cl. H04N 5/66; H04N 5/74; H04N 5/64

(52) U.S. Cl. 348/836; 348/748; 348/739

(57) ABSTRACT

A projection display apparatus includes a screen; an optical engine projecting an image beam to the screen; a driving unit having a first circuit part and a second circuit part driving the optical engine; an upper cabinet supporting the screen, and allowing the image beam to be projected; and a lower cabinet provided under the upper cabinet, and including an accommodating part accommodating the optical engine and the driving unit, one of the first circuit part and the second circuit part being supported to an upper part of the lower cabinet, and the other thereof being supported to another part of the lower cabinet.

### CROSS-REFERENCE TO RELATED APPLICATIONS

This application claims priority from Korean Patent Application No. 2006-0020652, filed on Mar. 3, 2006, in the Korean Intellectual Property Office, the disclosure of which is incorporated herein by reference.

### BACKGROUND OF INVENTION

1. Field of Invention

The present invention relates to a projection display apparatus, and more particularly, to a projection display apparatus improved in a driving unit disposing configuration.

2. Description of the Related Art

Generally, a display apparatus includes an image processing device such as a computer, a television, a projector, a PDA, etc. to supply an image to a user. Especially, a projection display apparatus uses an optical unit to project an image beam to a screen, and is provided as a projector, a projection television, etc.

The projection display apparatus includes a casing, an optical engine mounted inside the casing to project an image beam, a reflecting mirror provided in a rear of the casing to reflect the projected image beam, and a screen provided in a front of the casing to display an image by means of the reflected image beam. Since the projection display apparatus can easily have a large-sized display part, it has become popular.

The optical engine is classified into a CRT (cathode ray tube) type, an LCD (liquid crystal display) type, a DLP (digital light processing) type, etc. Hereinafter, the LCD type of optical engine will be described by way of example.

A conventional projection display apparatus includes a screen displaying an image, a front casing supporting the screen and provided with an opening through which the screen is exposed, and a rear casing provided behind the front casing. The projection display apparatus includes a reflecting mirror provided to an inner side of the rear casing, an optical engine provided between the front casing and the rear casing and projecting an image beam to the reflecting mirror, a driving unit driving the optical engine, and an accommodating part provided to the casings to accommodate the optical engine and the driving unit.

The driving unit includes a power supplying unit supplying power to an LCD or a light source, and a circuit board for driving the LCD or the light source. Heat having a high temperature may be generated from the optical engine or the driving unit. The driving unit is provided under the optical engine or in the same plane thereas, and is connected with the optical engine through a cable. The accommodating part may accommodate a unit for supplying power and a cooling unit as well as the optical engine and the driving unit as necessary.

The optical engine projects an image beam to the screen through the reflecting mirror to display an image thereto.

However, the conventional projection display apparatus needs a big accommodating space because the optical engine, the driving unit, the cooling unit, etc. are stacked or are disposed in the same plane.

### SUMMARY OF THE INVENTION

Illustrative, non-limiting exemplary embodiments of the present invention overcome the above disadvantages, and other disadvantages not described above.

Accordingly, an apparatus of the present invention provides a projection display apparatus improved in a disposing configuration of a driving unit driving an optical engine.

The foregoing and/or other aspects of the present invention can be achieved by providing a projection display apparatus comprising a screen, further comprising: an optical engine projecting an image beam to the screen; a driving unit comprising a first circuit part and a second circuit part driving the optical engine; an upper cabinet supporting the screen, and allowing the image beam to be projected; and a lower cabinet provided under the upper cabinet, and comprising an accommodating part accommodating the optical engine and the driving unit, one of the first circuit part and the second circuit part being supported to an upper part of the lower cabinet, and the other thereof being supported to another part of the lower cabinet.

According to this exemplary embodiment of the present invention, the lower cabinet comprises: an inclined surface provided to an upper part of the accommodating part, and comprising an image opening through which the image beam projected from the optical engine transmits, and a bottom surface provided to a lower part of the accommodating part.

According to this exemplary embodiment of the present invention, the first circuit part is supported to the bottom surface, and the second circuit part is supported to the inclined surface.

According to this exemplary embodiment of the present invention, the lower cabinet comprises a supporting bracket supporting the second circuit part, and the inclined surface comprises at least one guiding part formed in a coupling direction so that the supporting bracket is slidably guided.

According to this exemplary embodiment of the present invention, the inclined surface comprises a first engaging part, and the supporting bracket comprises a second engaging part engaged to the first engaging part to maintain engagement to the inclined surface.

Still further, the supporting bracket may be coupled to the inclined surface by means of a screw.

Still further, the lower cabinet comprises an entrance through which the optical engine and the first circuit part enter, and the projection display apparatus further comprises a rear cover opening and closing the entrance.

According to yet another aspect of the present invention, the optical engine comprises a light source part comprising an LED (light emitting diode) to emit light.

Still further, the optical engine comprises a display element comprising a DMD (digital micro-mirror device) to form an image by using light supplied from the light source part.

Additionally, the first circuit part comprises a main circuit board driving the display element, and a first power supplying part supplying power to the display element and the main circuit board.

Additionally, the second circuit part comprises an LED circuit board driving the light source part, and a second power supplying part supplying power to the light source part and the LED circuit board.

Additionally, the first circuit part further comprises a main power supplying part supplying power to the first and second power supplying parts.

According to another aspect of the present invention, the lower cabinet further comprises a cooling part cooling at least one of the optical engine and the second circuit part, and an engine supporting bracket supporting the optical engine.

### BRIEF DESCRIPTION OF THE DRAWINGS

The above and/or other aspects and advantages of the prevent invention will become apparent and more readily appreciated from the following description of the exemplary embodiments, taken in conjunction with the accompanying drawings, in which:

FIG. 1 is a perspective view illustrating a projection display apparatus according to an embodiment of the present invention;

FIG. 2 is a partial perspective view illustrating a bottom surface of a lower cabinet in FIG. 1;

FIG. 3 is a partial perspective view illustrating a lower cabinet in FIG. 1;

FIG. 4 is a rear view illustrating the projection display apparatus in FIG. 1;

FIG. 5 is a side sectional view illustrating the projection display apparatus in FIG. 4;

FIG. 6 is a perspective view illustrating the assembling processes of a lower cabinet in FIG. 1;

FIG. 7 is another perspective view illustrating the assembling processes of a lower cabinet in FIG. 1; and

FIG. 8 is a sectional view illustrating an operation of the projection display apparatus in FIG. 1.

### DETAILED DESCRIPTION OF THE ILLUSTRATIVE, NON-LIMITING EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

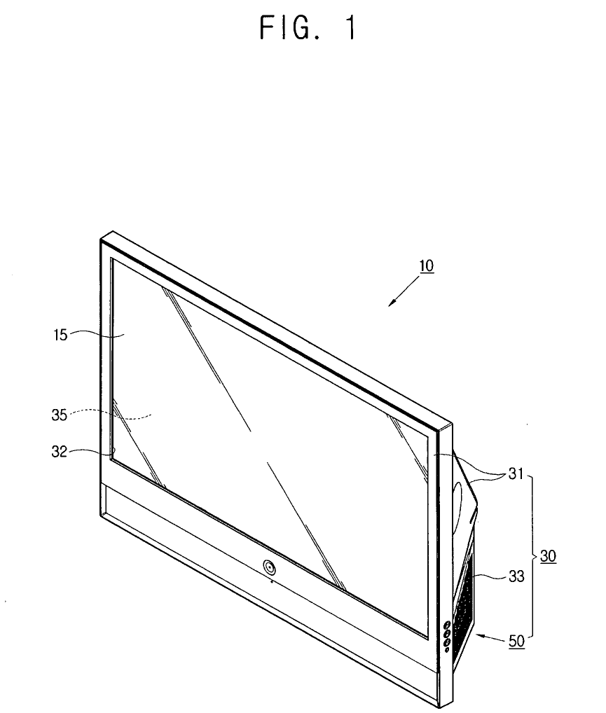

As shown in FIGS. 1 to 5, a projection display apparatus 10 according to an embodiment of the present invention includes a screen 15, an optical engine 20 projecting an image beam to the screen 15, a driving unit 40 provided with first circuit parts 43, 45, 46 and 47 and second circuit parts 41 and 49 driving the optical engine 20, an upper cabinet 31 supporting the screen 15 and allowing an image beam to be projected, and a lower cabinet 50 provided under the upper cabinet 31 with an accommodating part 51 accommodating the optical engine 20 and the driving unit 40. The second circuit parts 41 and 49 are supported to an inclined surface 52 positioned in an upper part of the accommodating part 51, and the first circuit parts 43, 45, 46 and 47 and the optical engine 20 are supported to other positions such as a bottom surface 65 positioned in a lower part of the accommodating part 51.

The screen 15 displays an image by means of an image beam projected from the optical engine 20. The screen 15 includes a lenticular lens and a fresnel lens having planar shapes, a sun-screen protecting the lenses, etc. The screen 15 is coupled to a front of the upper cabinet 31 to supply an image to a user.

A reflecting mirror 17 has a planar shape to reflect an image beam projected from the optical engine 20 to the screen 15, and is mounted to an upper rear part of a casing 30 to have an inclination.

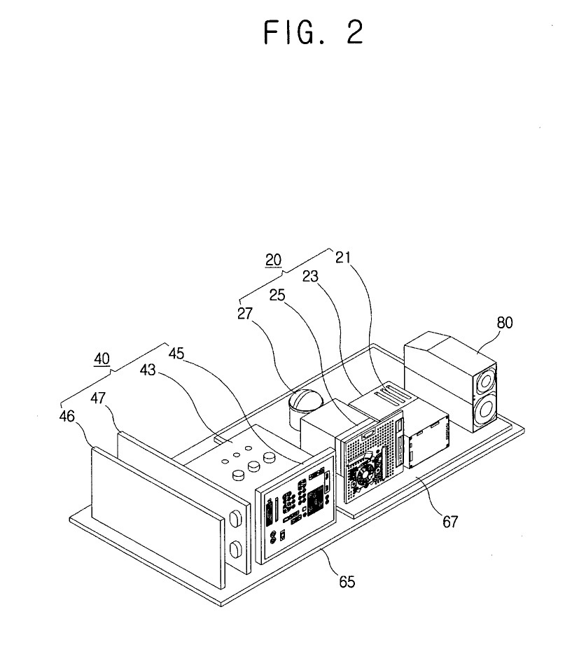

As shown in FIG. 2, the optical engine 20 projects an image beam to the reflecting mirror 17 disposed in a lower part of an inner space 35 of the casing 30. The optical engine 20 includes a light source part 21 emitting light, an illuminating part 23 converting the light emitted from the light source part 21 to a converged uniform parallel light, a display element 25 supplied with the light converted through the illuminating part 23 to form an image, and a projecting lens part 27 enlarging and projecting the image formed by the display element 25 to the screen 15. Since heat having a high temperature may be generated from the light source part 21, the display element 25, etc., the optical engine 20 may include a cooling part 80 such as a cooling fan (not shown) cooling a heated part.

The optical engine 20 is provided as a DLP (digital light processing) type using a DMD (digital micro-mirror device). Alternatively, the optical engine 20 may be provided as a CRT (cathode ray tube), an LCD (liquid crystal display), etc.

The light source part 21 preferably includes three LEDs (light emitting diodes) respectively emitting a red light, a green light and a blue light. Alternatively, the light source part 21 may include other known light sources. The light source part 21 may respectively include at least two red LEDs, green LEDs and blue LEDs, and at least six LEDs. Since the light source part 21 is provided as the LED, the projection display apparatus 10 can omit a separate device extracting a red light, a green light and a blue light from a white light. Thus, the optical engine 20 can be minimized, and reduce power consumption.

The illuminating part 23 includes a condenser lens (not shown) converting light emitted from the light source part 21 to a parallel light, and a polarizing plate (not shown) disposed behind the condenser lens to convert light transmitted through the condenser lens to a polarized rectilinear light. The illuminating part 23 includes a couple of fly eye lenses (not shown) disposed next to the polarizing plate to enhance uniformity of light reaching the display element 25 according to an arrangement thereof, and a relay lens (not shown) converging the light transmitted through the fly eye lenses to the display element 25. Here, the condenser lens and the polarizing plate may be selectively, provided to the illuminating part 23 according to a state of light, etc. as necessary. Alternatively, the illuminating part 23 may be provided with a light pipe.

Accordingly, light emitted from the light source part 21 is converted to a uniform parallel light and converged to the display element 25 by means of the illuminating part 23.

The display element 25 is supplied with light from the illuminating part 23 to form an image, and may include an LCD (liquid crystal display) element and an LCOS (liquid crystal on silicon) element, etc. The display element 25 preferably includes a DMD element. The DMD element includes a lot of pixels respectively having micro mirrors disposed in a plane, and is driven to independently turn on or off the pixels so the respective mirrors have a first reflecting angle or a second reflecting angle. The DMD element has a response speed bigger than an LCD element, an LCOS, etc., thereby more smoothly displaying an image.

The projecting lens part 27 includes a plurality of lenses to enlarge an image formed by the display element 25 and project it to the screen 15.

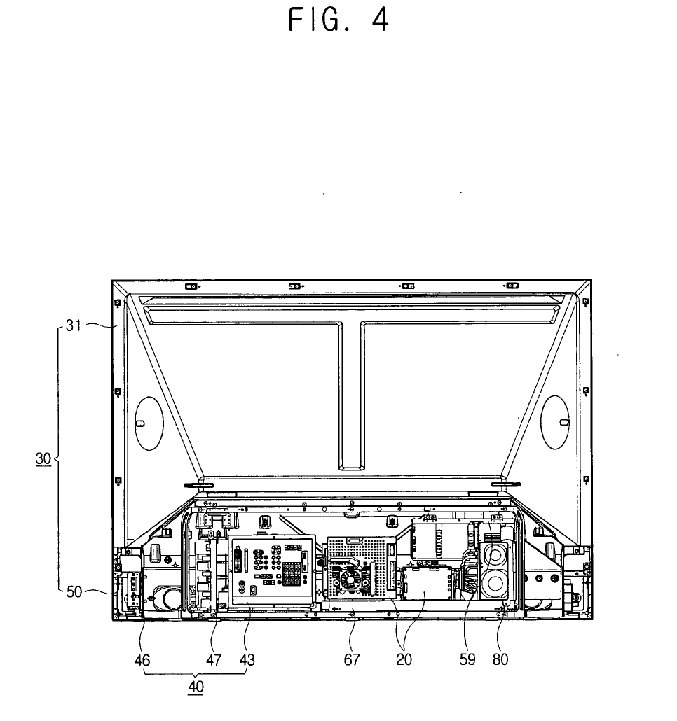

As shown in FIGS. 1 and 4, the casing 30 includes the upper cabinet 31 supporting the screen 15 and allowing an image beam to be transmitted therethrough, and the lower cabinet 50 provided under the upper cabinet 31 and including the accommodating part 51 accommodating the optical engine 20 and the driving unit 40.

The reflecting mirror 17 is coupled to an upper inner side of the upper cabinet 31. The upper cabinet 31 is formed with the inner space 35 in which an image beam is projected. The upper cabinet 31 is provided with an opening 32 formed therethrough to expose the screen 15. The upper cabinet 31 may include a screen bracket (not shown) disposed in rear of the screen 15 to support a circumference of the screen 15, and a coupling means (not shown) such as a screw coupling the screen bracket thereto. The upper cabinet 31 includes a through hole (not shown) through which an image projected from the projecting lens part 27 is transmitted. Under the upper cabinet 31, the lower cabinet 50 is disposed to support the optical engine 20 and the second circuit parts 41 and 49.

A rear cover 33 opens and closes an entrance 69 of the lower cabinet 50 and forms an external appearance. The rear cover 33 is formed with a ventilating hole (not shown) smoothing cooling of the cooling part 80, and a thru hole (not shown) exposing the first circuit parts 43, 45 (i.e., a terminal part 45 of a main circuit board 43) to be connected to a power supplying device or other electronic devices.

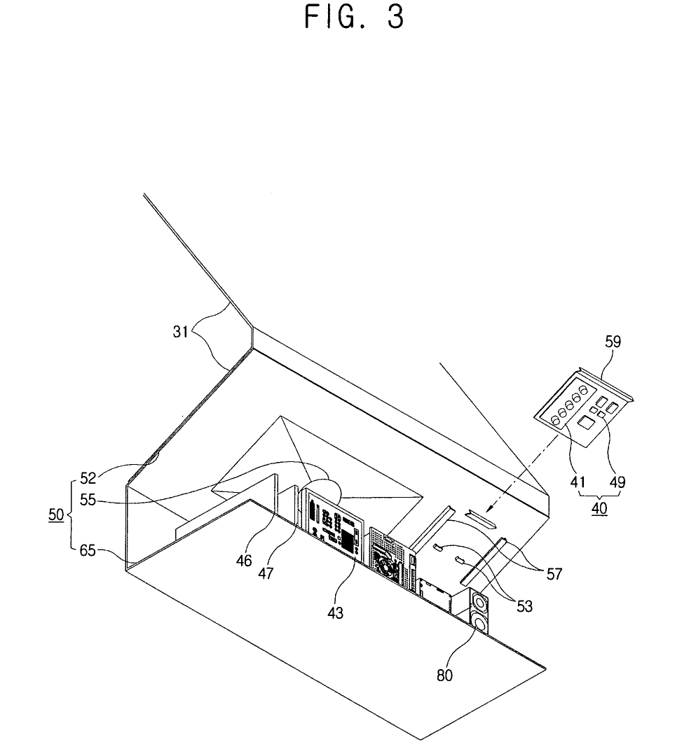

As shown in FIGS. 2 and 3, the driving unit 40 includes the first circuit parts 43, 45, 46 and 47 and the second circuit parts 41, 49 to drive the optical engine 20. The first circuit parts 43, 45, 46 and 47 includes the main circuit board 43 driving the display element 25, a first power supplying part 47 supplying power to the main circuit board 43, and a main power supplying part 46 supplying power to the first power supplying part 47 and a second power supplying part 49. The second circuit parts 41 and 49 includes an LED circuit board 41 driving the light source part 21, and the second power supplying part 49 supplying power to the light source part 21 and the LED circuit board 41. The first and second power supplying parts 47 and 49 may be provided as a switching mode power supply or the like.

The LED circuit board 41 may control the light source part 21 so that the respective LEDs independently emit red, green and blue lights based on an external signal. The LED circuit board 41 is supported to a supporting bracket 59 to be coupled to the inclined surface 52. The LED circuit board 41 is electrically connected with the light source part 21 and the second power supplying part 49 through a cable (not shown).

The main circuit board 43 drives the display element 25 based on a signal. The main circuit board 43 is supported to the bottom surface 65 of the lower cabinet 50, and is communicatably connected with the display element 25 and the first power supplying part 47 through a cable (not shown). The main circuit board 43 may be electrically connected with the LED circuit board 41. The main circuit board 43 may be supplied with power from an outside source or communicate with an outside device through the terminal part 45.

The main power supplying part 46 supplies power to the first and second power supplying parts 47 and 49. The main power supplying part 46 may be disposed to a part of the inclined surface 52.

The first power supplying part 47 converts power received from the main power supplying part 46 to be suitable to the main circuit board 43 and the display element 25, and supplies it thereto. The first power supplying part 47 is disposed to the bottom surface 65 adjacently to the main power supplying part 46.

The second power supplying part 49 converts power received from the main power supplying part 46 to be suitable to the LED circuit board 41 and the light source part 21, and supplies it thereto. The second power supplying part 49 is supported to the supporting bracket 59 of the lower cabinet 50.

Accordingly, the first power supplying part 47 and the second power supplying part 49 can be separately disposed to the bottom surface 65 and the inclined surface 52, thereby efficiently using space and slimming the projection display apparatus 10.

As shown in FIGS. 2 and 3, the lower cabinet 50 is provided under the upper cabinet 31, accommodates the optical engine 20 and the first circuit parts 43, 45, 46 and 47, and includes the entrance 69 through which the optical engine 20 and the first circuit parts 43, 45, 46 and 47 enter. A rear side and the opposite sides of the lower cabinet 50 are opened. The lower cabinet 50 includes the inclined surface 52 formed with an image opening 55 which is disposed to an upper part of the accommodating part 51 and is transmitted by an image beam projected from the optical engine 20 therethrough, and the bottom surface 65. The lower cabinet 50 includes the supporting bracket 59 supporting the LED circuit board 41 and the second power supplying part 49, and an engine supporting bracket 67 supporting the optical engine 20 and the cooling part 80.

The inclined surface 52 is separated from the inner space 35 to contact to a lower inclined surface of the upper cabinet 31. The inclined surface 52 includes the image opening 55 through which an image beam from the projecting lens part 27 transmits. The inclined surface 52 is coupled with the supporting bracket 59 by means of a screw, etc. The inclined surface 52 includes a first engaging part 53 engaging the supporting bracket 59 to the inclined surface 52 when the projection display apparatus 10 is assembled or repaired. The inclined surface 52 includes at least one guiding part 57 protruding from a surface thereof along a mounting direction to slidably guide the supporting bracket 59 when the supporting bracket 59 is mounted and detached. Thus, the supporting bracket 59 can be detachably mounted without difficulty.

The inclined surface 52 of the lower cabinet 50 is preferably formed of metal, but may be formed of a plastic material. The inclined surface 52 may be integrally provided with the upper cabinet 31 as necessary.

As shown in FIG. 3, the supporting bracket 59 supports at least one of the second circuit parts 41, 49, and is coupled with the inclined surface 52. The supporting bracket 59 preferably supports the LED circuit board 41 and the second power supplying part 49. A disposition of the supporting bracket 59 and details of the second circuit parts 41 and 49 supported by the supporting bracket 59 can be determined according to the size of the projection display apparatus 10, the kinds of the light source part 21 and the display element 25, cooling method, etc. The supporting bracket 59 includes a second engaging part 61 protruding from a surface thereof to bend so that the supporting bracket 59 is engaged to the inclined surface 52 when the projection display apparatus 10 is assembled or repaired. The supporting bracket 59 is coupled to the inclined surface 52 by means of a screw or the like. Thus, the first circuit parts 43, 45, 46 and 47 and the second circuit parts 41 and 49 can be separately disposed to the bottom surface 65 and the inclined surface 52 of the lower cabinet 50, thereby efficiently using space, slimming the projection display apparatus 10, and easily maintaining engagement of the second circuit parts 41 and 49. Also, cooling efficiency can be enhanced.

The bottom surface 65 forms a bottom of the accommodating part 51, and supports at least one of the optical engine 20 and the first circuit parts 43, 45, 46 and 47. The bottom surface 65 includes the engine supporting bracket 67 supporting the optical engine 20 and the cooling part 80.

As shown in FIG. 2, the engine supporting bracket 67 supports the optical engine 20 and the cooling part 80, and is supported to the bottom surface 65. The engine supporting bracket 67 may have a figure further supporting at least one of the first circuit parts 43, 45, 46 and 47 as necessary. Thus, in an assembling process or repairing process, the optical engine 20 and the cooling part 80 can be assembled to the engine supporting bracket 67 before being coupled to the bottom surface 65 of the lower cabinet 50. The engine supporting bracket 67 may include a guide (not shown) protruding from the bottom surface 65 to slidably guide when being assembled or repaired, and a figure (not shown) like the first engaging part 53 and the second engaging part 61 of the inclined surface 52 so that the engine supporting bracket 67 maintains engagement to the bottom surface 65. Thus, although the projection display apparatus 10 is slimmed to be compact, it can be easily assembled or repaired by detaching the engine supporting bracket 67 from the bottom surface 65. The engine supporting bracket 67 may further support at least one of the main power supplying part 46, the main circuit board 43 and the first power supplying part 47, and may be provided in a plurality as necessary.

The entrance 69 is formed in a rear side of the lower cabinet 50 so that the optical engine 20 and the first circuit parts 43, 45, 46 and 47 enter therethrough. The entrance 69 is opened or closed by the rear cover 33, and may include a sealing member sealing the rear cover 33 therewith.

Alternatively, the optical engine 20 and the first circuit parts 43, 45, 46 and 47 may be variously disposed to the lower cabinet 50 according to the size of the projection display apparatus 10, the kinds of the light source part 21 and the display element 25, cooling method, etc.

As shown in FIGS. 2 and 3, the cooling part 80 includes a cooling fan (not shown) cooling heated parts of the optical engine 20, the first circuit parts 43, 45, 46 and 47, and the second circuit parts 41 and 49, and a duct (not shown) guiding air of the cooling fan to the heated parts. Thus, the cooling part 80 can efficiently cool the optical engine 20, the first circuit parts 43, 45, 46 and 47, and the second circuit parts 41 and 49.

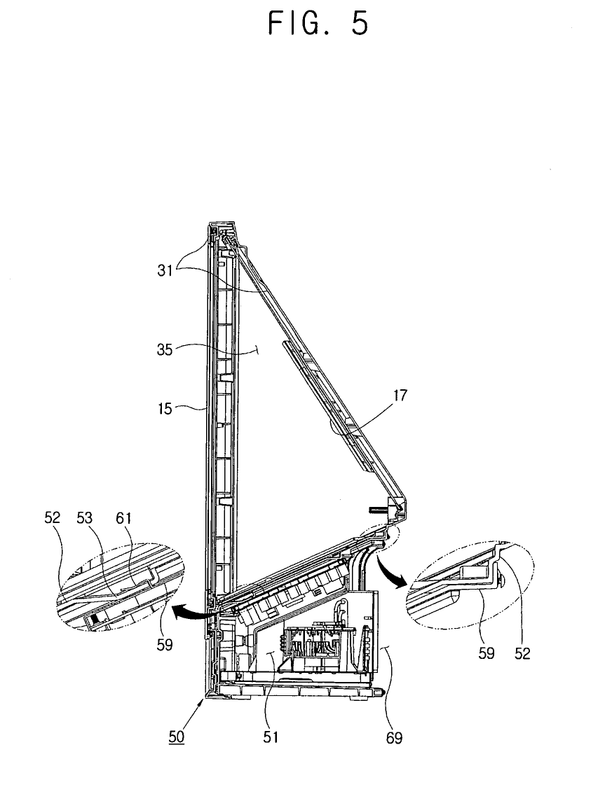

Hereinafter, an assembling process of the projection display apparatus 10 will be described by referring to FIGS. 5 to 7.

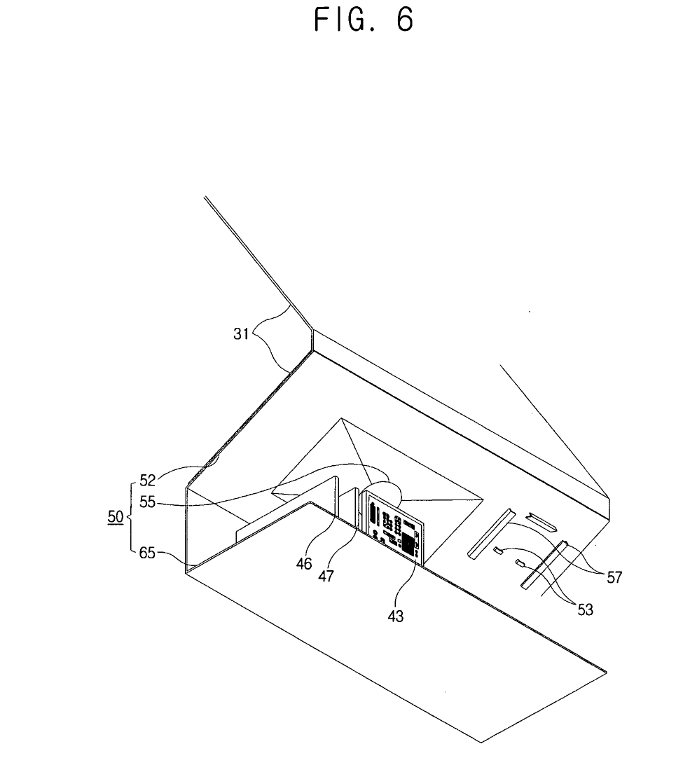

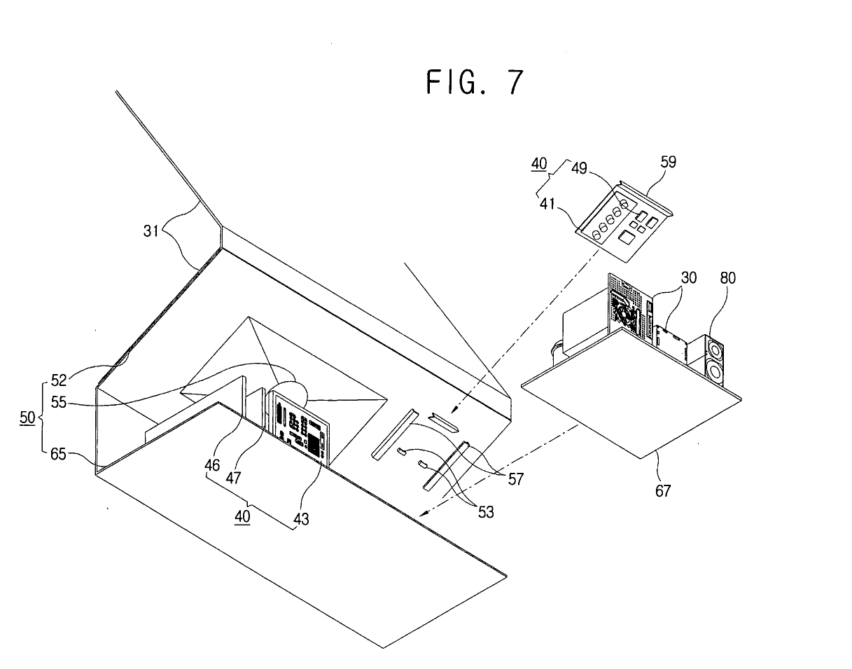

Referring to FIG. 5, at first, the screen 15 is coupled to the opening 32 of the upper cabinet 31. Then, the upper cabinet 31 to which the reflecting mirror 17 is coupled is coupled to the lower cabinet 50 by means of screws or the like. Referring to FIG. 6, the main power supplying part 46, the first power supplying part 47 and the main circuit board 43 are sequentially coupled to the bottom surface 65 of the lower cabinet 50 from a side to the other side thereof by means of screws or the like. On the other hand, the optical engine 20 and the cooling part 80 are coupled to the engine supporting bracket 67 by means of screws or the like. The LED circuit board 41 and the second power supplying part 49 are coupled to the supporting bracket 59 by means of screws or the like. Then, referring to FIG. 7, the engine supporting bracket 67 is coupled to the bottom surface 65 by means of screws or the like. The supporting bracket 59 slides along the guiding part 57 of the inclined surface 52 so that the second engaging part 61 of the supporting bracket 59 is engaged to the first engaging part 53 of the inclined surface 52 by means of screws or the like, and is mounted to the inclined surface 52. Then, the main power supplying part 46, the first power supplying part 47, the second power supplying part 49, the display element 25, the light source part 21, etc. are electrically connected through a cable, a signal bus, etc. The rear cover 33 is coupled to the lower cabinet 50 or the casing 30 by means of screws or the like so that the terminal part 45 of the main circuit board 43 is exposed.

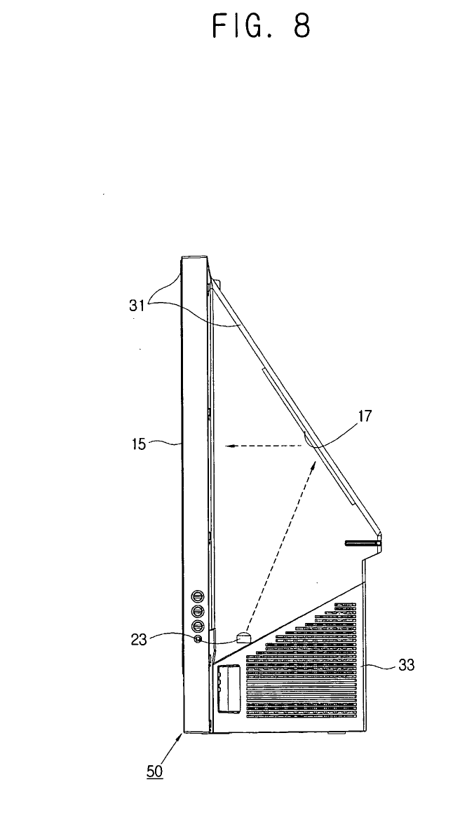

Hereinafter, an operation of the projection display apparatus 10 will be described by referring to FIG. 8.

When power is supplied to the optical engine 20 and the driving unit 40 from the main power supplying part 46, the first and second power supplying parts 47 and 49 convert it to predetermined powers, and supply to the main circuit board 43, the display element 25, the light source part 21, and the LED circuit board 41. The LED circuit board 41 selectively drives the LEDs of the light source part 21 to emit light. The main circuit board 43 drives the display element 25 to form an image beam by using the light emitted from the light source part 21. The formed image beam is projected toward the reflecting mirror 17 through the projecting lens part 27. Then, the reflecting mirror 17 reflects the image beam to the screen to be displayed.

Accordingly, the projection display apparatus according to the present invention can separately dispose the first circuit parts and the second circuit parts to efficiently use space, thereby being slimmed. Also, the projection display apparatus includes the first and second engaging parts, the guiding part, the supporting bracket, and the engine supporting bracket, and accordingly, it can be easily assembled or repaired.

As described above, the present invention provides a projection display apparatus which can separately dispose a driving unit, thereby efficiently using space and achieving a slim design.

Also, the present invention provides a projection display apparatus which can be easily used, assembled and repaired.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A projection display apparatus comprising:
a screen;
an optical engine for projecting an image beam to the screen;
a driving unit comprising a first circuit part and a second circuit part for driving the optical engine;
an upper cabinet supporting the screen, and for allowing the image beam to be projected onto the screen; and
a lower cabinet provided under the upper cabinet, and comprising an accommodating part accommodating the optical engine and the driving unit,
one of the first circuit part and the second circuit part being supported to an upper part of the lower cabinet, and another of the first circuit part and the second circuit part being supported to another part of the lower cabinet.

2. The projection display apparatus according to claim 1, wherein the lower cabinet comprises:
an inclined surface provided to an upper part of the accommodating part, and comprising an image opening through which the image beam projected from the optical engine transmits, and
a bottom surface provided to a lower part of the accommodating part.

3. The projection display apparatus according to claim 2, wherein the first circuit part is supported to the bottom surface, and
the second circuit part is supported to the inclined surface.

4. The projection display apparatus according to claim 3, wherein the lower cabinet comprises a supporting bracket supporting the second circuit part, and
the inclined surface comprises at least one guiding part for slidably guiding the supporting bracket onto the inclined surface.

5. The projection display apparatus according to claim 4, wherein the inclined surface comprises a first engaging part, and
the supporting bracket comprises a second engaging part for engaging with the first engaging part to maintain engagement of the supporting bracket to the inclined surface.

6. The projection display apparatus according to claim 4, wherein the supporting bracket is coupled to the inclined surface by means of a screw.

7. The projection display apparatus according to claim 1, wherein the lower cabinet comprises an entrance through which the optical engine and the first circuit part enter, and
the projection display apparatus further comprises a rear cover for opening and closing the entrance.

8. The projection display apparatus according to claim 1, wherein the optical engine comprises a light source part comprising an LED to emit light.

9. The projection display apparatus according to claim 8, wherein the optical engine comprises a display element comprising a DMD to form an image by using light supplied from the light source part.

10. The projection display apparatus according to claim 9, wherein the first circuit part comprises a main circuit board driving the display element, and a first power supplying part supplying power to the display element and the main circuit board.

11. The projection display apparatus according to claim 10, wherein the second circuit part comprises an LED circuit board driving the light source part, and a second power supplying part supplying power to the light source part and the LED circuit board.

12. The projection display apparatus according to claim 11, wherein the first circuit part further comprises a main power supplying part supplying power to the first and second power supplying parts.

13. The projection display apparatus according to claim 10, wherein the lower cabinet further comprises a cooling part cooling at least one of the optical engine and the second circuit part, and an engine supporting bracket supporting the optical engine.

14. The projection display apparatus according to claim 3, wherein the optical engine comprises a light source part comprising an LED to emit light.

15. The projection display apparatus according to claim 14, wherein the optical engine comprises a display element comprising a DMD to form an image by using light supplied from the light source part.

16. The projection display apparatus according to claim 15, wherein the first circuit part comprises a main circuit board driving the display element, and a first power supplying part supplying power to the display element and the main circuit board.

17. The projection display apparatus according to claim 16, wherein the second circuit part comprises an LED circuit board driving the light source part, and a second power supplying part supplying power to the light source part and the LED circuit board.

18. The projection display apparatus according to claim 17, wherein the first circuit part further comprises a main power supplying part supplying power to the first and second power supplying parts.

19. The projection display apparatus according to claim 16, wherein the lower cabinet further comprises a cooling part cooling at least one of the optical engine and the second circuit part, and an engine supporting bracket supporting the optical engine.
